(19) United States
(12) Patent Application Publication
(10) Pub. No.: US 2026/0094440 A1
(43) Pub. Date: Apr. 2, 2026

(54) VIDEO TIMELINE ASSEMBLY BASED ON TEXT INSTRUCTIONS USING MACHINE LEARNING

(71) Applicant: Adobe Inc., San Jose, CA (US)

(72) Inventors: Fabian David CABA HEILBRON, San Jose, CA (US); Jui-Hsien WANG, Sammamish, WA (US); Bryan RUSSELL, San Francisco, CA (US); Luis Alejandro PARDO GONZALEZ, Bogota (CO); Josef SIVIC, Prague (CZ)

(73) Assignee: Adobe Inc., San Jose, CA (US)

(21) Appl. No.: 18/900,232

(22) Filed: Sep. 27, 2024

(51) Int. Cl. G06V 20/40

(52) U.S. Cl. CPC G06V 20/46; G06V 20/49

(57) ABSTRACT

Embodiments are trained to generate a timeline of digital media assets based on natural language instructions using a machine learning model. The method may include receiving an input including digital media assets, an input visual timeline, and text input, where the text input indicates a natural language instruction describing a modification to the input visual timeline using the digital media assets. The disclosed systems and methods further comprise generating a first set of tokens for the digital media assets, a second set of tokens for the input visual timeline, and a third set of tokens for the text input. The disclosed systems and methods further comprise processing, by a large language model, the first set of tokens, the second set of tokens, and the third set of tokens to generate an output set of tokens and generating a reconstructed visual timeline using the output set of tokens.

### BACKGROUND

The creation of digital content is important for users trying to engage with a target audience. Video content creation can involve the organization and assembly of digital media assets into a visual timeline that displays an ordered visualization of the images and/or video clips included in the video. As a collection of digital media assets can be extensive, locating and organizing desired digital media assets into a visual timeline can be a challenging and time-consuming task.

### SUMMARY

Introduced here are techniques/technologies that allow machine learning models of a digital design system to perform a modification to the digital media assets of an input visual timeline based on natural language text instructions describing the modification.

More specifically, in one or more embodiments, a digital design system receives an input that includes a collection of digital media assets (e.g., images and/or video clips), an input visual timeline that can include one or more digital media assets from the collection of digital media assets, and text instructions describing a video assembly task. Example video assembly task types that the digital design system can identify in the text instructions can include the insertion, removal, replacement, and swapping of digital media assets. The digital design system separately tokenizes the collection of digital media assets, the input visual timeline, and the text instructions. The tokens for each digital media asset can include an identifier token that identifies the digital media asset from the collection of digital media assets based on a numerical value or file name, and a visual token that identifies the visual features of the corresponding digital media asset. The tokens for the input visual timeline can include an identifier token to identify the digital media assets that are included in the input visual timeline. The tokens for the text instructions can include text tokens that encode the natural language text instructions. The tokens are then passed through a generative model that includes a large language model trained to reason over the tokens to generate a set of output tokens representing a new visual timeline with the modification to the input visual timeline indicated in the text instructions.

In one or more embodiments, the digital design system is trained using an automatically generated paired dataset of input visual timelines and output visual timelines. In such embodiments, a collection of digital media assets, an input visual timeline, and output visual timeline, and text instructions for modifications to the input visual timeline are generated from input visual sequences and assembly task candidates.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of generating a timeline of digital media assets based on natural language instructions using a machine learning model in accordance with one or more embodiments;

FIG. 2 illustrates a diagram of a generating an output set of tokens from processing digital media assets, an input visual timeline, and text instructions through a digital design system in accordance with one or more embodiments;

FIG. 3 illustrates example video timeline assembly tasks performed by a digital design system on an input visual timeline in accordance with one or more embodiments;

FIG. 4 illustrates a diagram of a process of training a digital design system to generate a timeline of digital media assets based on natural language instructions in accordance with one or more embodiments;

FIG. 5 illustrates a schematic diagram of a digital design system in accordance with one or more embodiments;

FIG. 6 illustrates a flowchart of a series of acts in a method of generating a timeline of digital media assets based on natural language instructions using a machine learning model in accordance with one or more embodiments; and

FIG. 7 illustrates a block diagram of an exemplary computing device in accordance with one or more embodiments.

### DETAILED DESCRIPTION

One or more embodiments of the present disclosure include a digital design system trained to modify an input visual timeline of digital media assets to generate an output video timeline by reasoning over a collection of digital media assets and natural language text instructions. Some existing video assembly techniques require a user to manually arrange images and videos to create a visual timeline. However, these techniques can be time-consuming, resulting in a poor user experience, particularly when the visual timeline or the collection of digital media assets is large. For example, manually locating particular video clips in an extensive collection and placing them in the timeline can slow down the creative process of the user. Further, many video assembly techniques require expertise in specialized software, which can be a barrier to entry for novice content creators. Other existing techniques are directed to automatic shot transitioning and B-roll recommendations. While these techniques provide creative guidance, they are not capable of performing user-instructed visual assembly tasks provided as natural language instructions.

To address these and other deficiencies in conventional systems, the digital design system of the present disclosure includes neural networks trained to process collections of digital media assets (e.g., images and/or video clips), encode the contents of input visual timelines, and ingest natural language text instructions to generate output visual timelines. The output visual timelines are generated by the neural networks after performing modifications to the input visual timelines based on identified video assembly tasks described in the natural language text instructions.

The digital design system of the present disclosure presents improved video timeline assembly that addresses the limitations of the existing solutions. Another advantage of the digital design system of the present disclosure is that through training the digital design system to reason over natural language text instructions, embodiments provide a more intuitive video creation interface for novices, mitigating the complexities associated with mastering traditional video editing tools and easing the management of digital media assets. An additional advantage of the digital design system of the present disclosure is that it can enable hands-free video editing through a speech-to-text interface. This would enable accessibility to users unable to edit via their hands or allow users to perform editing operations on devices where it can otherwise be cumbersome to edit videos (e.g., mobile devices).

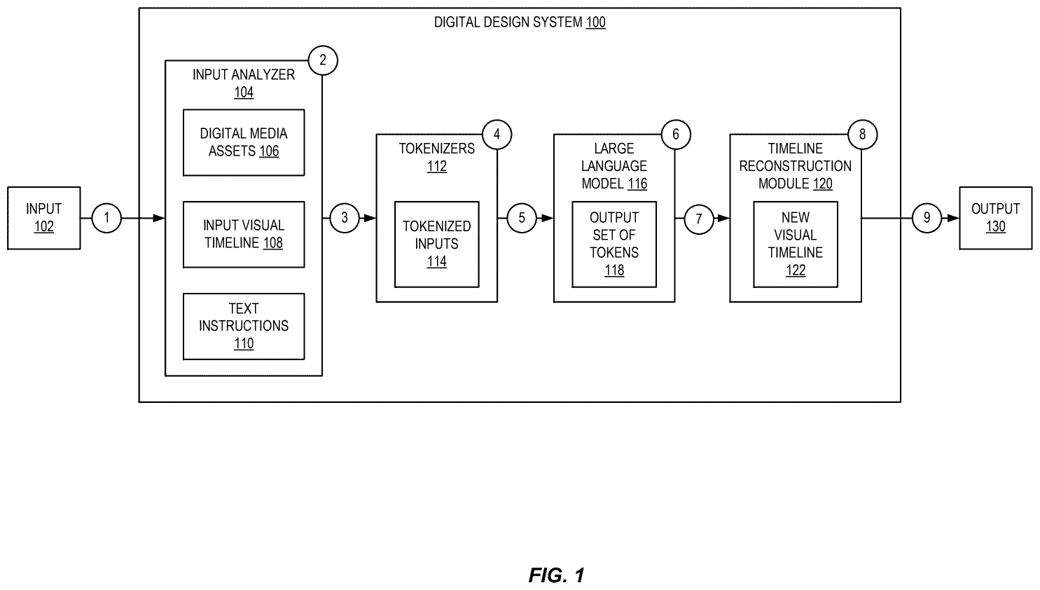

FIG. 1 illustrates a diagram of a process of generating a timeline of digital media assets based on natural language instructions using a machine learning model in accordance with one or more embodiments. As shown in FIG. 1, a digital design system 100 receives an input 102, as shown at numeral 1. For example, the digital design system 100 receives the input 102 from a user via a computing device or from a memory or storage location. In one or more embodiments, the input 102 includes digital media assets 106, an input visual timeline 108, and text instructions 110. In one or more embodiments, the input 102 can be provided through the use of a graphical user interface (GUI). In one or more embodiments, the input 102 can be uploaded directly or the user can provide a URL to a location storing the input 102. For example, the text instructions 110 can be natural language text entered into a text box, or a user can indicate a storage location (e.g., on a computing device) or a URL to a location storing the text instructions 110.

In one or more embodiments, the digital media assets 106 can include a plurality of images and/or video clips. In one or more embodiments, the input visual timeline 108 includes a subset of the plurality of images and/or video clips in the digital media assets 106. In other embodiments, the input visual timeline 108 can be an empty timeline that does not include any images or video clips. In one or more embodiments, the text instructions 206 include natural language text describing one or more assembly tasks (e.g., modifications to the input visual timeline 108). Example assembly tasks in the text instructions 206 can include the removal or insertion of a digital media asset, the replacement of a digital media asset in the input visual timeline 108 with another digital media asset of the digital media assets 106, or the swapping of one digital media asset for another digital media asset within the input visual timeline 108. In one or more embodiments, the text instructions 206 can reference digital media assets 106 based on their visual content or by an identifier (e.g., file name). Example text instructions 206 can include, “Add the shot where the girl is eating ice cream to the end of the sequence” and “replace the shot ID 16 with shot ID 58.” In one or more embodiments, a limit on the text instructions 206 is based on a size limitation of the large language model 116.

The digital design system 100 includes an input analyzer 104 that receives the input 102. In some embodiments, the input analyzer 104 is configured to extract the digital media assets 106, the input visual timeline 108, and the text instructions 110 from the input 102, at numeral 2.

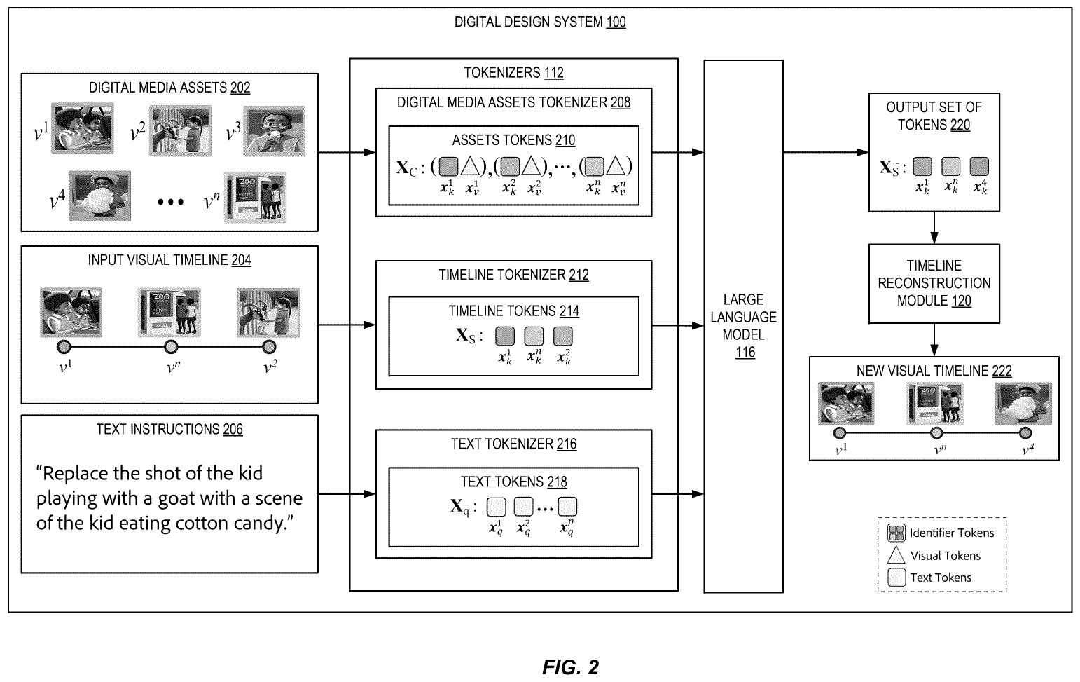

The input analyzer 104 then sends the digital media assets 106, the input visual timeline 108, and the text instructions 110 to tokenizers 112, as shown at numeral 3. In one or more embodiments, the tokenizers 112 generate tokenized inputs 114 from the digital media assets 106, the input visual timeline 108, and the text instructions 110. In one or more embodiments, the tokenizers 112 include a digital media assets tokenizer configured to tokenize the images and/or video clips in the digital media assets 106, a timeline tokenizer configured to tokenize the contents of the input visual timeline 108, and a text tokenizer configured to tokenize the text instructions 206. Additional details of the tokenizers 112 are described with respect to FIG. 2.

After the tokenizers 112 generate the tokenized inputs 114, the tokenized inputs 114 sent to a large language model 116, as shown at numeral 5. In one or more embodiments, the large language model 116 is a multimodal large language model, or a similar neural network. In one or more embodiments, a neural network includes deep learning architecture for learning representations of audio and/or video. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

The large language model 116 is trained to predict an output set of tokens 118 representing a new or modified video timeline, at numeral 6. In one or more embodiments, the large language model 116 generates the output set of tokens 118 based on the text instructions 110 using the digital media assets 106 and the input visual timeline 108. In one or more embodiments, the output set of tokens 118 is an updated sequence of tokens representing a subset of the digital media assets 106 that follow the instruction provided by the input text instructions 110.

In one or more embodiments, the output set of tokens 118 are then sent to a timeline reconstruction module 120, as shown at numeral 7. The timeline reconstruction module 120 constructs a new visual timeline 122 based on the output set of tokens 118, at numeral 8. In one or more embodiments, each token in the output set of tokens 118 is mapped to a digital media asset (e.g., an image or a video clip) from the input digital media assets 106. The timeline reconstruction module 120 can then render the new visual timeline 122 using the corresponding digital media assets.

After the timeline reconstruction module 120 generates the new visual timeline 122, the new visual timeline 122 can be sent as an output 130, as shown at numeral 9. In one or more embodiments, after the process described above in numerals 1-8, the output 130 is sent through a communications channel to the user device or computing device that provided the input requesting the modification to the input visual timeline 108, to another computing device associated with the user or another user, or to another system or application.

FIG. 2 illustrates a diagram of a generating an output set of tokens from processing digital media assets, an input visual timeline, and text instructions through a digital design system in accordance with one or more embodiments. In FIG. 2, digital media assets 202, input visual timeline 204, and text instructions 206 are received as inputs, or retrieved, by the digital design system 100. The digital media assets 202, input visual timeline 204, and text instructions 206 are processed through tokenizers 112. In one or more embodiments, the tokenizers 112 include a digital media assets tokenizer 208, a timeline tokenizer 212, and a text tokenizer 216.

As illustrated in FIG. 2, the collection of n digital media assets 202, C, can be denoted as:

$$C = \{ {v}^{1} , {v}^{2} , … , {v}^{n} \}$$

where vⁱ represents a digital media asset (e.g., an image or video clip). The digital media assets 202 are passed to the digital media assets tokenizer 208 to generate asset tokens 210.

In one or more embodiments, the goals of the digital media assets tokenizer 208 is to represent the collection of digital media assets 202 as an array of unique identifier tokens and visual tokens to enable a large language model 116 to process the visual content of the images and/or videos clips in the digital media assets 202. For example, after passing the digital media assets 202 through the digital media assets tokenizer 208, each digital media asset, vⁱ, can be represented by a token pair: an identifier token and a visual token. As illustrated in FIG. 2, the identifier tokens are represented by shaded rounded square objects and the visual tokens are represented by unshaded triangle objects. Each identifier token serves to distinctly identify the corresponding digital media asset within the collection. For example, the identifier token can indicate an assigned numerical value or file name for the corresponding digital media asset. The visual token can encapsulate the visual information associated with the corresponding digital media asset.

In one or more embodiments, the digital media assets tokenizer 208 includes a mapping function, [symbol] , that generates a unique identifier token,

$${x}_{k}^{i} ,$$

for each digital media asset, vⁱ, of the digital media assets 202. In one or more embodiments, the mapping function, [symbol] , obtains a unique identifier token,

$${x}_{k}^{i} ,$$

by assigning a token from a set of previously tokenized integers. In embodiments, the mapping function operates as a lookup table that helps to assign (and locate) the unique identifier token of a given digital media asset.

The digital media assets tokenizer 208 further includes a visual encoder that embeds every digital media asset, vⁱ, to produce a visual token,

$${x}_{v}^{i} .$$

Ine one or more embodiments, the visual encoder ingests a digital media asset, vⁱ, and outputs a visual token,

$${x}_{v}^{i} .$$

In one or more embodiments, a pretrained visual encoder, g, ingests and extracts visual representations from the input digital media assets 202, and a projection layer, h_{γ}(⋅), maps these visual representations into a visual token that is aligned with the input space of the large language model 116 (e.g., matches a dimensionality of the large language model 116). Each digital media asset, vⁱ, is then represented as a tuple,

$$( {x}_{k}^{i} , {x}_{v}^{i} )$$

that includes a unique identifier token and a visual token, respectively, such that the entire array of asset tokens 210 can be expressed as follows:

$${X}_{C} = [ ( {x}_{k}^{1} , {x}_{v}^{1} ) , ( {x}_{k}^{2} , {x}_{v}^{2} ) , … , ( {x}_{k}^{n} , {x}_{v}^{n} ) ]$$

In one or more embodiments, the goal of the timeline tokenizer 212 is to map a sequence of digital media assets within an input visual timeline (e.g., input visual timeline 204) to their corresponding identifier tokens, which were allocated during the digital media assets 202 initial tokenization by the digital media assets tokenizer 208. In such embodiments, by utilizing the pre-existing tokens, the timeline tokenizer 212 avoids the need for re-tokenizing digital media assets as they appear in the input visual timeline. Preventing redundant visual tokenization can enable the large language model 116 to handle more extensive collections of digital media assets and longer input visual timelines. Each identifier token assigned by the timeline tokenizer 212 acts as a reference (or pointer) to the (typically high-dimensional) visual token.

Assuming an input visual timeline is expressed as follows:

$$S = \{ {v}^{S 1} , {v}^{S 2} , … , {v}^{Sl} \}$$

where v^{Si} represents the i-th digital media asset in the input visual timelines, and l is the length of the input visual timeline. Using the mapping function, [symbol] , the timeline tokenizer 212 can retrieve the identifier token for each digital media asset, v^{Si}, and construct timeline tokens, X_{S}, which can be expressed as follows:

$${X}_{S} = [ {x}_{k}^{S 1} , {x}_{k}^{S 2} , … , {x}_{k}^{Sl} ]$$

Continuing the example of FIG. 2, the timeline tokenizer 212 maps the digital media assets in the input visual timeline 204, S, to the corresponding identifier tokens the digital media assets 202 generated by the digital media assets tokenizer 208. As illustrated in FIG. 2, the input visual timeline 204 include three digital media assets (e.g., images or video clips) that correspond to digital media assets as follows:

$$S = \{ {v}^{1} , {v}^{n} , {v}^{2} \}$$

resulting in timeline tokens 214, as follows:

$${X}_{S} = [ {x}_{k}^{1} , {x}_{k}^{n} , {x}_{k}^{2} ]$$

In one or more embodiments, the goal of the text tokenizer 216 is to map the sequence of strings/words into a discrete set of p tokens. Given an input text instruction, q, the text tokenizer 216 can map the input text instruction into a set of text tokens representing the full input text instructions. In one or more embodiments, the text tokenizer 216 is a byte-level Byte-Pair Encoding (BPE) text tokenizer of the large language model 116. Continuing the example of FIG. 2, the text instruction requests the replacement of “the shot of the kid playing with the goat” with the “scene of the kid eating cotton candy.” Using the digital media assets 202, the text instruction is to replace digital media asset v² with digital media asset v⁴. In one or more embodiments, the text tokenizer 216 maps the text instructions 206 into text tokens 218, as follows:

$${X}_{q} = [ {x}_{q}^{1} , {x}_{q}^{2} , … , {x}_{q}^{p} ]$$

As illustrated in FIG. 2, the text tokens 218 are represented by unshaded rounded square objects.

After generating the asset tokens 210, the timeline tokens 214, and the text tokens 218, they can be provided to the large language model 116. In one or more embodiments, the input to the large language model 116 is the union of the asset tokens 210, the timeline tokens 214, and the text tokens 218, which can be expressed as:

$$X = [ {X}_{C} , {X}_{S} , {X}_{q} ]$$

In one or more embodiments, the large language model 116 is trained to assemble and edit visual timelines of digital media assets (e.g., images and/or video clips). In one or more embodiments, the large language model 116 is a multimodal large language model capable of managing multiple multimodal tasks, reasoning over long sequences, and encapsulating knowledge from a plurality of sources. In one or more embodiments, the goal of the large language model 116 is to generate a new, or updated, visual timeline, X_{S}, based on input text instructions 206.

In one or more embodiments, the large language model 116, f_{θ}(⋅), is parameterized by θ. The input to the large language model 116 is the sequence of multimodal tokens X. At inference, the large language model 116 produces an output set of tokens 220. In one or more embodiments, the output set of tokens 220 are a sequence of identifier tokens that represent the digital media assets of the new or updated visual timeline, such that:

$${f}_{θ} ( X ) \to {X}_{\tilde{S}} = [ {x}_{k}^{\tilde{S} 1} , {x}_{k}^{\tilde{S} 2} , … , {x}_{k}^{\tilde{S} Q} ]$$

where Q is the length of the new visual timeline 222 (e.g., the number of digital media assets from the digital media assets 202) and

$${x}_{k}^{\tilde{S} i}$$

is the identifier token for the 1-th digital media asset on the new visual timeline 222. The length of the new visual timeline 222 can be greater than the input visual timeline 204 if the text instructions 206 included the addition of a digital media asset to the input visual timeline 204. The length of the new visual timeline 222 can be smaller than the input visual timeline 204 if the text instructions 206 included the removal of a digital media asset to the input visual timeline 204. The length of the new visual timeline 222 can be the same length (e.g., have the same number of digital media assets) as the input visual timeline 204 if the text instructions 206 included the swapping of one digital media asset for another digital media asset

In one or more embodiments, to generate the new visual timeline 222 from the output set of tokens 220, the output set of tokens 220 are passed to a timeline reconstruction module 120. In one or more embodiments, given the output set of tokens 220, X_{\tilde{S}}, produced by the large language model 116, f_{θ}(⋅), the timeline reconstruction module 120 reconstructs the new visual timeline 222, S, by mapping each output token in the output set of tokens 220 to their corresponding digital media asset of the digital media assets 202. In one or more embodiments, the mapping is performed using a reverse mapping operation from the mapping function, [symbol] . As illustrated in FIG. 2, the new visual timeline 222 includes the modification to the input visual timeline 204 that was indicated by the text instructions 206 (i.e., “the shot of the kid playing with the goat” has been replaced with the “scene of the kid eating cotton candy”).

In one or more embodiments, the digital design system 100 can process multiple input visual timelines concurrently, e.g., multiple timeline tracks in the video editor. In such embodiments, the digital design system 100 can process natural language text instructions that include video assembly tasks that operate on the multiple input visual timelines. In such embodiments, each input visual timeline can be associated with, or assigned, a timeline identifier, which can be referred to in natural language text instructions. For example, the natural language text instruction can request, “Swap shot ID 45 in timeline ID 1 with shot ID 34 in timeline ID 2.”

In one or more embodiments, the digital design system 100 can perform additional video assembly task types, including modifying an input visual timeline to add an audio sequence to one or more images and/or video clips in the input visual timeline. In such embodiments, the digital media assets (e.g., digital media assets 106, digital media assets 202, etc.) can further include audio clips or audio sequences. In some embodiments, audio clips can be stored separately and processed separately from visual clips (e.g., image, video clips, etc.). In other embodiments, the audio clips and visual clips can be stored together. In one or more embodiments, audio features for the audio clips can be generated by a pretrained audio encoder. In one or more embodiments, the digital design system 100 can include an audio tokenizer configured to tokenize audio sequences into a token pair, including an identifier token and an audio token, where the audio token describes the audio features of a corresponding audio sequence.

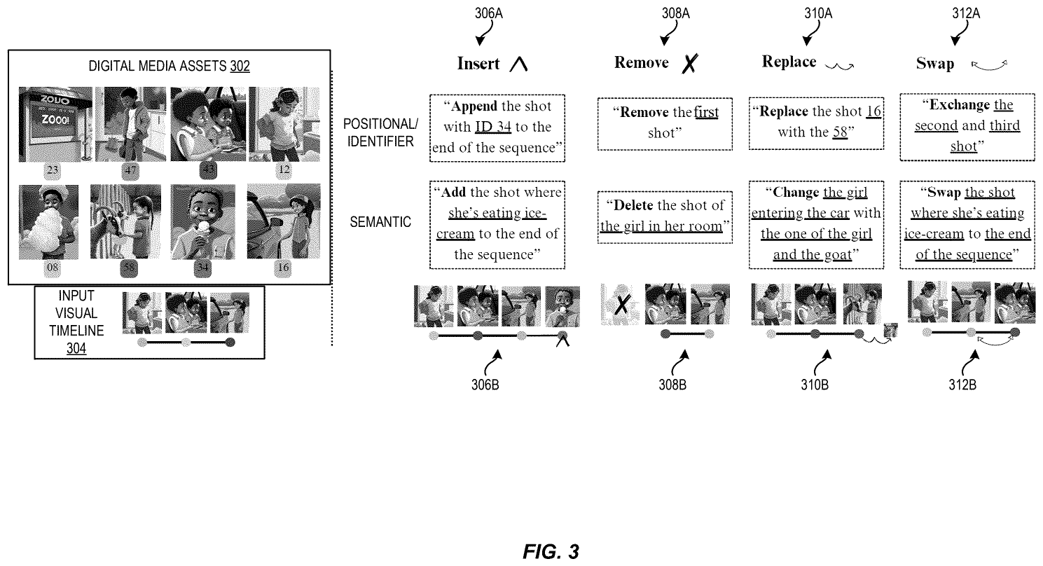

FIG. 3 illustrates example video timeline assembly tasks performed by a digital design system on an input visual timeline in accordance with one or more embodiments. The input visual timeline 304 indicates the initial state of the timeline, where the input visual timeline 304 includes a subset of images and/or video clips from the digital media assets 302. The examples illustrated in FIG. 3 highlight the ability of the digital design system (e.g., digital design system 100) to interpret and execute assembly task operations, or edits to an input visual timeline 304, based on either positional information (e.g., location within the input visual timeline 304), asset identification (e.g., an identifier value), or semantic information (e.g., a description of the visual content of the asset).

Video timeline assembly task 306A is a natural language text instruction to insert an asset from the digital media assets 302 into the input visual timeline 304. As illustrated in FIG. 3, the asset indicated for insertion at the end of the input visual timeline 304 can be described either using an identifier (e.g., “ID 34”) or semantically (e.g., “she's eating ice cream”). The resulting output visual timeline 306B has the indicated asset added to the end of the input visual timeline 304.

Video timeline assembly task 308A is a natural language text instruction to remove an asset from the input visual timeline 304. As illustrated in FIG. 3, the asset indicated for removal from the beginning of the input visual timeline 304 can be described either positionally (e.g., “first shot”) or semantically (e.g., “the girl in her room”). The resulting output visual timeline 308B has the indicated asset removed from beginning of the input visual timeline 304.

Video timeline assembly task 310A is a natural language text instruction to replace an asset in the input visual timeline 304 with a different asset from the digital media assets 302. As illustrated in FIG. 3, the assets indicated for replacement can be described either using an identifier (e.g., “16” and “58”) or semantically (e.g., “the girl entering the car” and “the one of the girl and the goat”). The resulting output visual timeline 310B has the indicated asset replaced with an asset from the digital media assets 302.

Video timeline assembly task 312A is a natural language text instruction to swap the locations of assets in the input visual timeline 304. As illustrated in FIG. 3, the assets indicated for swapping can be described positionally (e.g., “the second shot” and “the third shot”). The natural language text instruction can also include a combination of positional references and semantic references (e.g., “the shot where she's eating ice cream” and “the end of the sequence”). The resulting output visual timeline 312B has the indicated assets swapped from their positions in the input visual timeline 304.

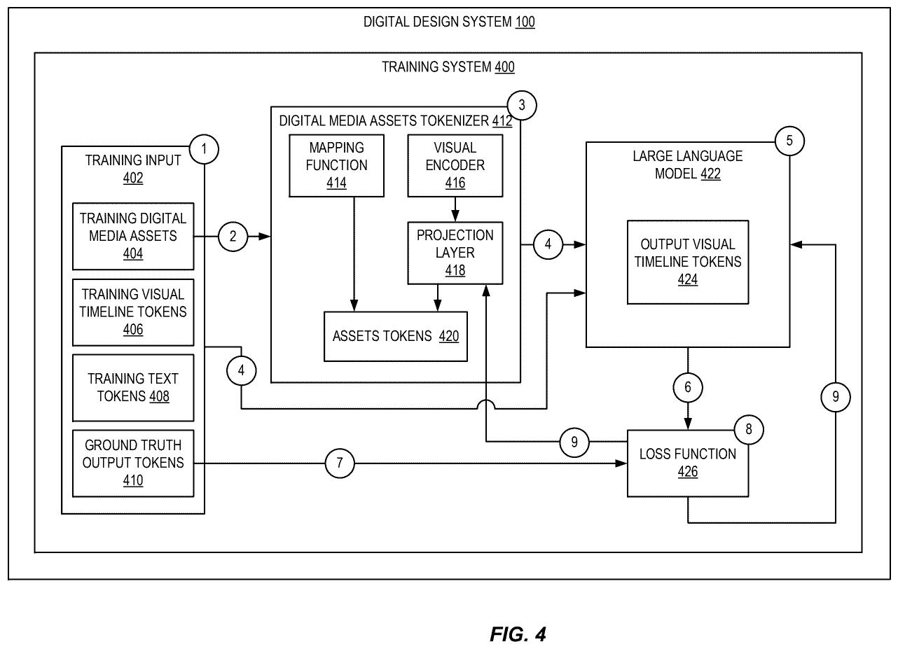

FIG. 4 illustrates a diagram of a process of training a digital design system to generate a timeline of digital media assets based on natural language instructions in accordance with one or more embodiments. As illustrated in FIG. 4, a digital design system includes a training system 400. The training system 400 includes a digital media assets tokenizer 412 and a large language model 422. In one or more embodiments, the training system 400 is configured to train a projection layer 418 of the digital media assets tokenizer 412 to map visual embeddings into visual tokens that are aligned with the large language model 422. The training system 400 is further configured to train a lightweight set of learnable Low-Rank Adapters (LoRA) of the large language model 422. In some embodiments, the training system 400 is a part of a digital design system 100. In other embodiments, the training system 400 can be a standalone system, or part of another system, and deployed to the digital design system 100. For example, the training system 400 may be implemented as a separate system implemented on electronic devices separate from the electronic devices implementing digital design system 100. As shown in FIG. 4, the training system 400 processes a training input 402, at numeral 1. For example, the digital design system 100 receives the training input 402 from a user via a computing device or from a memory or storage location. The training input 402 can include training digital media assets 404, training visual timeline tokens 406, training text tokens 408, and ground truth output tokens.

In one or more embodiments, the dataset, D, used for training the digital design system 100 can include four types of basic assembly tasks and two types of cues (e.g., for referencing a digital media asset in a visual timeline or in the collection of digital media assets). In one or more embodiments, the four basic assembly tasks include: insert (in) a digital media asset from the collection of digital media assets into the visual timeline, remove (rm) a digital media asset from the visual timeline, replace (rp) a digital media asset from the visual timeline with one from the collection of digital media assets, and swap (sw) two digital media assets in the visual timeline. In one or more embodiments, the two types of cues include: positional cue, p, where the user refers to a specific digital media asset by its identifier or position in the visual timeline, and semantic cue, r, where the user refers to a specific digital media asset by a natural language description of its visual content. In other embodiments, there may be fewer, greater, or different basic assembly tasks and types of cues than those described herein.

In one or more embodiments, the combination of assembly tasks and cues results in a set of eight assembly tasks, T={t_{c}}, where t is one of the four assembly tasks {in, rm, rp, sw} and c is one of the two types of cues {p, r}. Additionally, each one of the tasks is associated with a corresponding transformation function, φₜ_{_{c}}, and a set of instruction templates, qₜ. In one or more embodiments, the transformation function is applied to an initial visual timeline, Sⁱ, to obtain a modified visual timeline, \tilde{S}ⁱ=φₜ_{_{c}}(Sⁱ). In one or more embodiments, the transformation function, φₜ_{_{c}}, is a timeline operation used to get a pair of input and target visual timelines. For example, the remove function, φᵣₘ_{_{c}} removes one digital media asset from the training visual timeline Sⁱ to get the target timeline \tilde{S}ⁱ. On the other hand, the set of instruction templates, qₜ, are templates that are filled up with the given cues, cⁱ. For example, a removing instruction, “Remove the last shot,” is created using the instruction template, qᵣₘ, “Remove the { } shot” and the cue “last.”

In one or more embodiments, a training dataset is generated from an existing data source, D, of one or more video reels (e.g., a video sequence that includes a plurality of video clips edited together). In one or more embodiments, constituent video clips are extracted from each video reel in \tilde{D} and a text caption is generated for each of the video clips (e.g., using a visual captioning system). Given the data source, \tilde{D}, a predefined set of assembly tasks, T, with corresponding transformations, φₜ_{_{c}}, and a predefined template text instructions, qₜ, a training visual timeline, Sⁱ, of length lⁱ from \tilde{D}, an assembly task, tⁱ, a cue for referencing one or more digital media assets, cⁱ, and an instruction template,

$${q}_{t}^{i} ,$$

corresponding to the assembly task are sampled.

The training visual timeline, Sⁱ, is obtained using transformation,

$${ϕ}_{{t}_{c}}^{i} .$$

The instruction template,

$${q}_{t}^{i} ,$$

is then populated using the cue, cⁱ. The collection of digital media assets, C, is then filled in with the lⁱ digital media assets in training visual timeline, Sⁱ, and |C|−lⁱ digital media assets from \tilde{D}. The process is repeated N times to obtain a visual assembly dataset, [symbol] , as follows:

$$D = \{ ( {S}^{1} , {\tilde{S}}^{1} , {q}^{1} , {C}^{1} ) , … ( {S}^{N} , {\tilde{S}}^{N} , {q}^{N} , {C}^{N} ) \}$$

The training digital media assets 404 are sent to a digital media assets tokenizer 412, as shown at numeral 2. The digital media assets tokenizer generates assets tokens 420 for each digital media asset in the training digital media assets 404, at numeral 3. The digital media assets tokenizer 412 includes a mapping function 414 that generates a unique identifier token for each digital media asset of the training digital media assets 404. In embodiments, the mapping function 414 operates as a lookup table that helps to assign (and locate) the unique identifier token of a given digital media asset. The digital media assets tokenizer 412 also includes a visual encoder 416. The visual encoder 416 generates a feature vector representation of the visual features of a corresponding digital media asset of the training digital media assets 404. A projection layer 418, h_{γ}(⋅), then maps these feature vector representations of the visual features into a visual token that is aligned with the input space of the large language model 422. The resulting assets tokens 420 for each digital media asset of the training digital media assets 404 thus includes an identifier token and a visual token. The assets tokens 420 generated by the digital media assets tokenizer 412, and the training visual timeline tokens 406 and the training text tokens 408 are then sent to large language model 422, as shown at numeral 4.

In one or more embodiments, the large language model 422 generates output visual timeline tokens 424, at numeral 5, in the process as described previously with respect to FIG. 2. The output visual timeline tokens 424 are then passed to the loss function 426, as shown at numeral 6. The ground truth output tokens 410 are also passed to the loss function 426, as shown at numeral 7.

Using the ground truth output tokens 410 and the output visual timeline tokens 424, the loss function 426 can calculate a loss, at numeral 8. In one or more embodiments, a negative log-likelihood (NLL) loss can be calculated, as follows:

$$Loss ( θ , γ ) = {\sum }_{i = 1}^{N} log log P ( {\hat{X}}^{i} \vert {X}^{i} ; θ , γ )$$

where N is the number of samples and P (\hat{X}ⁱ|Xⁱ; θ, γ) is the probability assigned by the model to the correct output tokens, \hat{X}ⁱ, given the input, Xⁱ, formed from the digital media assets tokens,

$${X}_{C}^{i} ,$$

the training visual timeline tokens,

$${X}_{S}^{i} ,$$

and the training text tokens,

$${X}_{q}^{i} ,$$

or sample i.

The calculated loss can then be backpropagated to train projection layer 418 of the digital media assets tokenizer 412 and a set of Low-Rank matrices to update the weights of the large language model 422. In some embodiments, the calculated loss can also be backpropagated to train the LoRA of the large language model 422 or the full large language model 422.

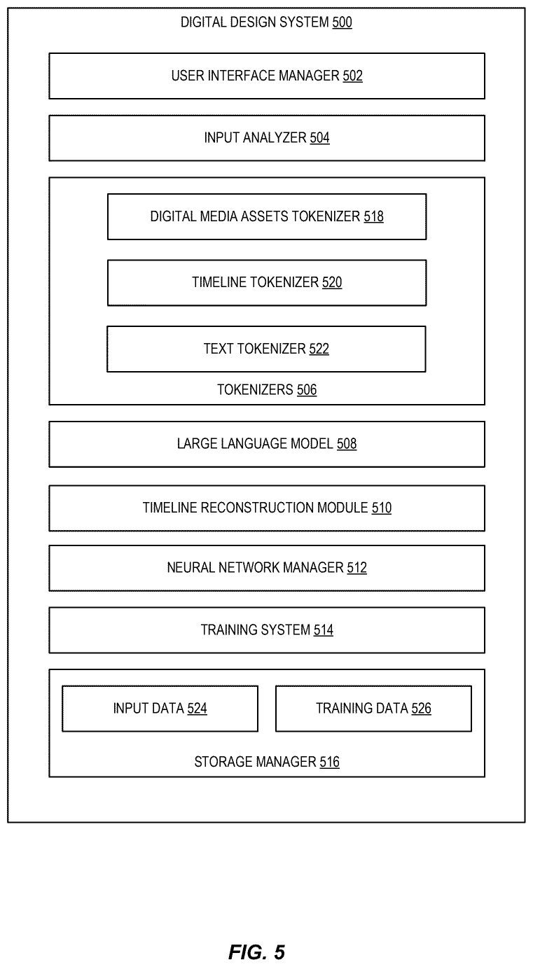

FIG. 5 illustrates a schematic diagram of a digital design system (e.g., “digital design system” described above) in accordance with one or more embodiments. As shown, the digital design system 500 may include, but is not limited to, a user interface manager 502, an input analyzer 504, tokenizers 506, a large language model 508, a timeline reconstruction module 510, a neural network manager 512, a training system 514, and a storage manager 516. The storage manager 516 includes input data 524 and training data 526.

As illustrated in FIG. 5, the digital design system 500 includes a user interface manager 502. For example, the user interface manager 502 allows users to provide input data to the digital design system 500. In some embodiments, the user interface manager 502 provides a user interface through which the user can upload one or more of digital media assets, an input visual timeline, and text instructions, as discussed above. Alternatively, or additionally, the user interface may enable the user to download one or more of the digital media assets, the input visual timeline, and the text instructions from a local or remote storage location (e.g., by providing an address (e.g., a URL or other endpoint) associated with a data source).

As further illustrated in FIG. 5, the digital design system 500 also includes an input analyzer 504. The input analyzer 504 analyzes an input received by the digital design system 500 to identify the digital media assets, the input visual timeline, and the text instructions.

As further illustrated in FIG. 5, the digital design system 500 also includes tokenizers 506. In one or more embodiments, the tokenizers 506 include a digital media assets tokenizer 518 configured to tokenize images and/or video clips in a collection of digital media assets, a timeline tokenizer 520 configured to tokenize the contents of the input visual timeline, and a text tokenizer 522 configured to tokenize the natural language text instructions.

As further illustrated in FIG. 5, the digital design system 500 also includes a large language model 508 trained to predict an output set of tokens representing a new or modified video timeline. In one or more embodiments, the large language model 508 generates the output set of tokens based on received text instructions and using the digital media assets and the input visual timeline. In one or more embodiments, the large language model 116 is a multimodal large language model, or a similar neural network. In one or more embodiments, a neural network includes deep learning architecture for learning representations of audio and/or video. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

The large language model 116 is trained to predict an output set of tokens 118 representing a new or modified video timeline at numeral 6. In one or more embodiments, the large language model 116 generates the output set of tokens 118 based on the text instructions 110 using the digital media assets 106 and the input visual timeline 108. In one or more embodiments, the output set of tokens 118 is an updated sequence of tokens representing a subset of the digital media assets 106 that follow the instruction provided by the input text instructions 110.

As further illustrated in FIG. 5, the digital design system 500 also includes a timeline reconstruction module 510. In one or more embodiments, the timeline reconstruction module 510 is configured to construct a new visual timeline based on the output set of tokens generated by the large language model 508. In one or more embodiments, the timeline reconstruction module 510 maps each token in the output set of tokens to a digital media asset (e.g., an image or a video clip) from a collection of input digital media assets.

As illustrated in FIG. 5, the digital design system 500 also includes a neural network manager 512. Neural network manager 512 may host a plurality of neural networks or other machine learning models, such as large language model 508. The neural network manager 512 may include an execution environment, libraries, and/or any other data needed to execute the machine learning models. In some embodiments, the neural network manager 512 may be associated with dedicated software and/or hardware resources to execute the machine learning models. Although depicted in FIG. 5 as being hosted by a single neural network manager 512, in various embodiments the neural networks may be hosted in multiple neural network managers and/or as part of different components.

As illustrated in FIG. 5 the digital design system 500 also includes training system 514. The training system 514 can teach, guide, tune, and/or train one or more neural networks. In particular, the training system 514 can train a neural network based on a plurality of training data. More specifically, the training system 514 can access, identify, generate, create, and/or determine training input and utilize the training input to train and fine-tune a neural network. In particular, the training system 514 can train, at least, the digital media assets tokenizer 518 and the large language model 508, based on training data.

As illustrated in FIG. 5, the digital design system 500 also includes the storage manager 516. The storage manager 516 maintains data for the digital design system 500. The storage manager 516 can maintain data of any type, size, or kind as necessary to perform the functions of the digital design system 500. The storage manager 516, as shown in FIG. 5, includes input data 524 and training data 526. In particular, the input data 524 may include digital media assets, input visual timelines, and text instructions received by the digital design system 500. The training data 526 can include a plurality of training datasets, as discussed in additional detail above. In particular, in one or more embodiments, the training data 526 includes training digital media assets, training input visual timelines, and training text instructions utilized by the training system 514 to train one or more neural networks.

Each of the components 502-516 of the digital design system 500 and their corresponding elements (as shown in FIG. 5) may be in communication with one another using any suitable communication technologies. It will be recognized that although components 502-516 and their corresponding elements are shown to be separate in FIG. 5, any of components 502-516 and their corresponding elements may be combined into fewer components, such as into a single facility or module, divided into more components, or configured into different components as may serve a particular embodiment.

The components 502-516 and their corresponding elements can comprise software, hardware, or both. For example, the components 502-516 and their corresponding elements can comprise one or more instructions stored on a computer-readable storage medium and executable by processors of one or more computing devices. When executed by the one or more processors, the computer-executable instructions of the digital design system 500 can cause a client device and/or a server device to perform the methods described herein. Alternatively, the components 502-516 and their corresponding elements can comprise hardware, such as a special purpose processing device to perform a certain function or group of functions. Additionally, the components 502-516 and their corresponding elements can comprise a combination of computer-executable instructions and hardware.

Furthermore, the components 502-516 of the digital design system 500 may, for example, be implemented as one or more stand-alone applications, as one or more modules of an application, as one or more plug-ins, as one or more library functions or functions that may be called by other applications, and/or as a cloud-computing model. Thus, the components 502-516 of the digital design system 500 may be implemented as a stand-alone application, such as a desktop or mobile application. Furthermore, the components 502-516 of the digital design system 500 may be implemented as one or more web-based applications hosted on a remote server. Alternatively, or additionally, the components of the digital design system 500 may be implemented in a suite of mobile device applications or “apps.”

As shown, the digital design system 500 can be implemented as a single system. In other embodiments, the digital design system 500 can be implemented in whole, or in part, across multiple systems. For example, one or more functions of the digital design system 500 can be performed by one or more servers, and one or more functions of the digital design system 500 can be performed by one or more client devices. The one or more servers and/or one or more client devices may generate, store, receive, and transmit any type of data used by the digital design system 500, as described herein.

In one implementation, the one or more client devices can include or implement at least a portion of the digital design system 500. In other implementations, the one or more servers can include or implement at least a portion of the digital design system 500. For instance, the digital design system 500 can include an application running on the one or more servers or a portion of the digital design system 500 can be downloaded from the one or more servers. Additionally or alternatively, the digital design system 500 can include a web hosting application that allows the client device(s) to interact with content hosted at the one or more server(s).

For example, upon a client device accessing a webpage or other web application hosted at the one or more servers, in one or more embodiments, the one or more servers can provide access to one or more files including a collection of digital media assets, an input visual timeline, and text instructions stored at the one or more servers. Moreover, the client device can receive a request (i.e., via user input) to modify the digital media assets of the input visual timeline based on a requested modification indicated by the text instructions. Upon receiving the request, the one or more servers can automatically perform the methods and processes described above. The one or more servers can provide a new or modified visual timeline to the client device for display to the user.

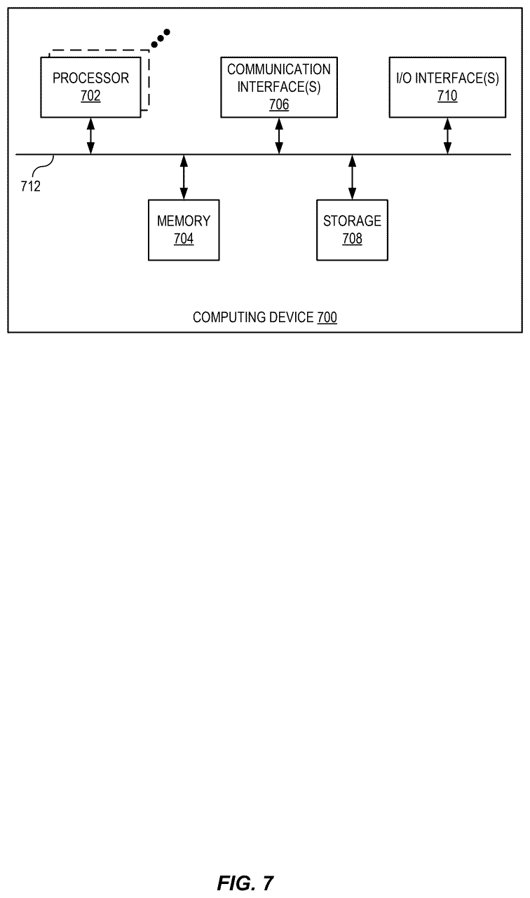

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 7. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 7.

The server(s) may include one or more hardware servers (e.g., hosts), each with its own computing resources (e.g., processors, memory, disk space, networking bandwidth, etc.) which may be securely divided between multiple customers (e.g., client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 7.

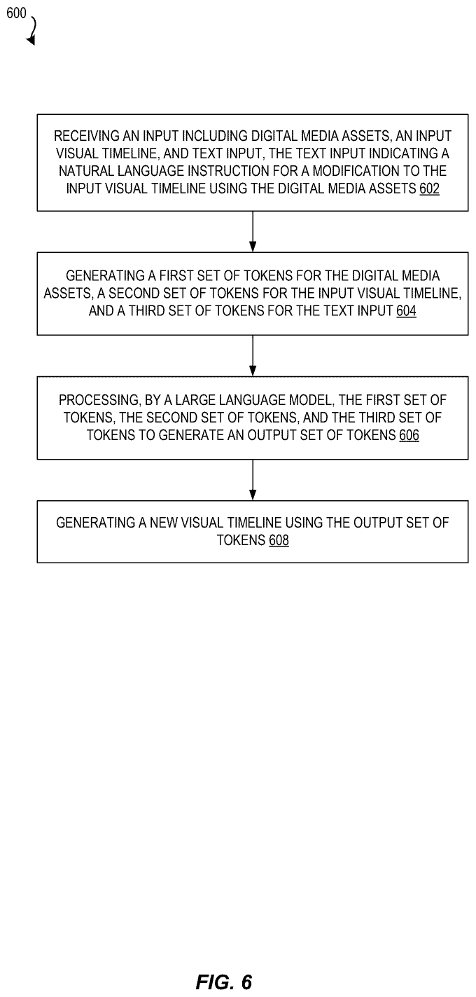

FIGS. 1-5, the corresponding text, and the examples, provide a number of different systems and devices that generate an output visual timeline of digital media assets based on natural language text instruction indicating modifications to an input visual timeline of digital media assets. In addition to the foregoing, embodiments can also be described in terms of flowcharts comprising acts and steps in a method for accomplishing a particular result. For example, FIG. 6 illustrates a flowchart of an exemplary method in accordance with one or more embodiments. The method described in relation to FIG. 6 may be performed with fewer or more steps/acts or the steps/acts may be performed in differing orders. Additionally, the steps/acts described herein may be repeated or performed in parallel with one another or in parallel with different instances of the same or similar steps/acts.

FIG. 6 illustrates a flowchart of a series of acts in a method of generating a timeline of digital media assets based on natural language instructions using a machine learning model in accordance with one or more embodiments. In one or more embodiments, the method 600 is performed in a digital medium environment that includes the digital design system 500. The method 600 is intended to be illustrative of one or more methods in accordance with the present disclosure and is not intended to limit potential embodiments. Alternative embodiments can include additional, fewer, or different steps than those articulated in FIG. 6.

As illustrated in FIG. 6, the method 600 includes an act 602 of receiving an input including digital media assets, an input visual timeline, and text input, the text input indicating a natural language instruction for a modification to the input visual timeline using the digital media assets. In one or more embodiments, the digital media assets, the input visual timeline, and the text input are provided to the digital design system for which a user is requesting a modification to the input visual timeline. In one or more embodiments, the digital design system receives the input from a user (e.g., via a computing device). In one or more embodiments, the user may select or provide the input in an application, or the user may submit the input to a web service or an application configured to receive inputs.

In one or more embodiments, the digital media assets can include images and/or video clips, where a subset of the digital media assets have been initially assembled into the input visual timeline. In one or more embodiments, the text input includes natural language text instructions describing an assembly task to be performed on the input visual timeline. Example assembly tasks can include inserting or removing an image or video clip from the input visual timeline, replacing an image or video clip in the input visual timeline with another image or video clip from the digital media assets, and swapping the locations of digital media assets in the input visual timeline. In one or more embodiments, the assembly task can indicate or reference digital media assets using an identifier value (e.g., “clipID 25”), positional information within the input visual timeline (e.g., “the last clip”), or semantic information describing the visual content (e.g., “the clip with the boy eating cotton candy”).

As illustrated in FIG. 6, the method 600 includes an act 604 of generating a first set of tokens for the digital media assets, a second set of tokens for the input visual timeline, and a third set of tokens for the text input. In one or more embodiments, the digital design system passes the digital media assets, the input visual timeline, and the text input through tokenizers to generate token representation of the input. In one or more embodiments, the digital media assets are passed through a digital media assets tokenizer to generate the first set of tokens. In such embodiments, digital media assets tokenizer generates a token pair for each digital media asset, where each token pair includes an identifier token generated by a mapping function and a visual token generated by a visual encoder. In one or more embodiments, the identifier token can be an assigned numeral value or a file name. In one or more embodiments, the visual token is generated by passing the digital media assets through the visual encoder to generate visual features (e.g., a feature vector) and mapping the visual features through a projection layer to match the dimensionality of the large language model.

In one or more embodiments, the input visual timeline is passed through a timeline tokenizer to generate the second set of tokens. In such embodiments, the timeline tokenizer generates an identifier token for each digital media asset in the timeline, where the identifier tokens correspond to the identifier tokens assigned to the digital media assets by the digital media assets tokenizer. In some embodiments, each identifier token in the second set of tokens includes a pointed an identifier token in the first set of tokens associated with the corresponding digital media asset in the input visual timeline. In one or more embodiments, the text input is passed through a text tokenizer to generate the third set of tokens. In such embodiments, the text tokenizer generates text tokens representing the natural language text instructions in the text input.

As illustrated in FIG. 6, the method 600 includes an act 606 of processing, by a large language model, the first set of tokens, the second set of tokens, and the third set of tokens to generate an output set of tokens. In one or more embodiments, the large language model is a multimodal large language model, or a similar neural network. In one or more embodiments, a neural network includes deep learning architecture for learning representations of audio and/or video. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

The large language model is trained to predict an output set of tokens representing a new or modified visual timeline. In one or more embodiments, the output set of tokens is an updated sequence of tokens representing a subset of the digital media assets after performance of the assembly task provided in the text input.

As illustrated in FIG. 6, the method 600 includes an act 608 of generating a new visual timeline using the output set of tokens. In one or more embodiments, the output set of tokens are provided to a timeline reconstruction module to generate the new visual timeline. In such embodiments, the timeline reconstruction module maps each token in the output set of tokens to a corresponding identifier token from the first set of identifier tokens to identify the corresponding digital media asset. After retrieving the digital media assets indicated by the output set of tokens, then timeline reconstruction module can render the retrieved digital media asset to generate a new video sequence.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates, in block diagram form, an exemplary computing device 700 that may be configured to perform one or more of the processes described above. One will appreciate that one or more computing devices such as the computing device 700 may implement the digital design system. As shown by FIG. 7, the computing device can comprise a processor 702, memory 704, one or more communication interfaces 706, a storage device 708, and one or more I/O devices/interfaces 710. In certain embodiments, the computing device 700 can include fewer or more components than those shown in FIG. 7. Components of computing device 700 shown in FIG. 7 will now be described in additional detail.

In particular embodiments, processor(s) 702 includes hardware for executing instructions, such as those making up a computer program. As an example, and not by way of limitation, to execute instructions, processor(s) 702 may retrieve (or fetch) the instructions from an internal register, an internal cache, memory 704, or a storage device 708 and decode and execute them. In various embodiments, the processor(s) 702 may include one or more central processing units (CPUs), graphics processing units (GPUs), field programmable gate arrays (FPGAs), systems on chip (SoC), or other processor(s) or combinations of processors.

The computing device 700 includes memory 704, which is coupled to the processor(s) 702. The memory 704 may be used for storing data, metadata, and programs for execution by the processor(s). The memory 704 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 704 may be internal or distributed memory.

The computing device 700 can further include one or more communication interfaces 706. A communication interface 706 can include hardware, software, or both. The communication interface 706 can provide one or more interfaces for communication (such as, for example, packet-based communication) between the computing device and one or more other computing devices 700 or one or more networks. As an example and not by way of limitation, communication interface 706 may include a network interface controller (NIC) or network adapter for communicating with an Ethernet or other wire-based network or a wireless NIC (WNIC) or wireless adapter for communicating with a wireless network, such as a WI-FI. The computing device 700 can further include a bus 712. The bus 712 can comprise hardware, software, or both that couples components of computing device 700 to each other.

The computing device 700 includes a storage device 708 includes storage for storing data or instructions. As an example, and not by way of limitation, storage device 708 can comprise a non-transitory storage medium described above. The storage device 708 may include a hard disk drive (HDD), flash memory, a Universal Serial Bus (USB) drive or a combination these or other storage devices. The computing device 700 also includes one or more input or output (“I/O”) devices/interfaces 710, which are provided to allow a user to provide input to (such as user strokes), receive output from, and otherwise transfer data to and from the computing device 700. These I/O devices/interfaces 710 may include a mouse, keypad or a keyboard, a touch screen, camera, optical scanner, network interface, modem, other known I/O devices or a combination of such I/O devices/interfaces 710. The touch screen may be activated with a stylus or a finger.

The I/O devices/interfaces 710 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 710 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
receiving an input including digital media assets, an input visual timeline, and text input, the text input indicating a natural language instruction for a modification to the input visual timeline using the digital media assets;
generating a first set of tokens for the digital media assets, a second set of tokens for the input visual timeline, and a third set of tokens for the text input;
processing, by a large language model, the first set of tokens, the second set of tokens, and the third set of tokens to generate an output set of tokens; and
generating a reconstructed visual timeline using the output set of tokens.

2. The method of claim 1, wherein the first set of tokens includes a token pair for each digital media asset of the digital media assets, wherein the token pair includes a first set of identifier tokens and a set of visual tokens representing features of a corresponding digital media asset, wherein the second set of tokens for the input visual timeline includes a second set of identifier tokens, and wherein the third set of tokens for the text input includes text tokens.

3. The method of claim 2, wherein the second set of tokens indicates an order of a subset of the digital media assets in the input visual timeline, and wherein each identifier token of the second set of identifier tokens includes a pointer to a token from the first set of tokens indicating a corresponding digital media asset.

4. The method of claim 2, wherein each identifier token of the first set of identifier tokens and the second set of identifier tokens is one of a file name or a numerical value.

5. The method of claim 2, wherein generating the reconstructed visual timeline using the output set of tokens further comprises:
mapping each token in the output set of tokens to a corresponding identifier token from the first set of identifier tokens; and
rendering the output set of tokens to generate a video sequence.

6. The method of claim 1, wherein the natural language instruction for the modification to the input visual timeline references one or more digital media assets of the digital media assets using at least one of: an identifier value, positional information within the input visual timeline, and a description of content of the one or more digital media assets.

7. The method of claim 2, further comprising:
generating each visual token of the set of visual tokens representing the features of the corresponding digital media asset by:
passing a digital media asset through a visual encoder to generate visual features of the digital media asset; and
mapping, by a projection layer, the visual features of the digital media asset into a visual token matching a dimensionality of the large language model.

8. The method of claim 1, wherein the large language model is trained using a training dataset, and wherein each training assembly task of the training dataset is created by:
extracting a plurality of training digital media assets from a data source of video sequences;
generating, using a transformation function, a training visual timeline from the plurality of training digital media assets, wherein the transformation function uses a training assembly task of a plurality of assembly tasks and a cue for referencing a digital media asset in the training visual timeline, and wherein the training assembly task of the plurality of assembly tasks is associated with an instruction template; and
generating, using the instruction template, a training natural language instruction including the training assembly task and the cue.

9. A non-transitory computer-readable medium storing executable instructions, which when executed by a processing device, cause the processing device to perform operations comprising:
receiving an input including digital media assets, an input visual timeline, and text input, the text input indicating a natural language instruction for a modification to the input visual timeline using the digital media assets;
generating a first set of tokens for the digital media assets, a second set of tokens for the input visual timeline, and a third set of tokens for the text input;
processing, by a large language model, the first set of tokens, the second set of tokens, and the third set of tokens to generate an output set of tokens; and
generating a reconstructed visual timeline using the output set of tokens.

10. The non-transitory computer-readable medium of claim 9, wherein the first set of tokens includes a token pair for each digital media asset of the digital media assets, wherein the token pair includes a first set of identifier tokens and a set of visual tokens representing features of a corresponding digital media asset, wherein the second set of tokens for the input visual timeline includes a second set of identifier tokens, and wherein the third set of tokens for the text input includes text tokens.

11. The non-transitory computer-readable medium of claim 10, wherein the second set of tokens indicates an order of a subset of the digital media assets in the input visual timeline, and wherein each identifier token of the second set of identifier tokens includes a pointer to a token from the first set of tokens indicating a corresponding digital media asset.

12. The non-transitory computer-readable medium of claim 10, wherein each identifier token of the first set of identifier tokens and the second set of identifier tokens is one of a file name or a numerical value.

13. The non-transitory computer-readable medium of claim 10, wherein the executable instructions to generate the reconstructed visual timeline using the output set of tokens further comprise:
mapping each token in the output set of tokens to a corresponding identifier token from the first set of identifier tokens; and
rendering the output set of tokens to generate a video sequence.

14. The non-transitory computer-readable medium of claim 9 wherein the natural language instruction for the modification to the input visual timeline references one or more digital media assets of the digital media assets using at least one of: an identifier value, positional information within the input visual timeline, and a description of content of the one or more digital media assets.

15. The non-transitory computer-readable medium of claim 10, wherein the executable instructions further comprise:
generating each visual token of the set of visual tokens representing the features of the corresponding digital media asset by:
passing a digital media asset through a visual encoder to generate visual features of the digital media asset; and
mapping, by a projection layer, the visual features of the digital media asset into a visual token matching a dimensionality of the large language model.

16. The non-transitory computer-readable medium of claim 9, wherein the large language model is trained using a training dataset, and wherein each training assembly task of the training dataset is created by:
extracting a plurality of training digital media assets from a data source of video sequences;
generating, using a transformation function, a training visual timeline from the plurality of training digital media assets, wherein the transformation function uses a training assembly task of a plurality of assembly tasks and a cue for referencing a digital media asset in the training visual timeline, and wherein the training assembly task of the plurality of assembly tasks is associated with an instruction template; and
generating, using the instruction template, a training natural language instruction including the training assembly task and the cue.

17. A system comprising:
a memory component; and
a processing device coupled to the memory component, the processing device to perform operations comprising:
receiving an input including digital media assets, an input visual timeline, and text input, the text input indicating a natural language instruction for a modification to the input visual timeline using the digital media assets;
generating a first set of tokens for the digital media assets, a second set of tokens for the input visual timeline, and a third set of tokens for the text input;
processing, by a large language model, the first set of tokens, the second set of tokens, and the third set of tokens to generate an output set of tokens; and
generating a reconstructed visual timeline using the output set of tokens.

18. The system of claim 17, wherein the first set of tokens includes a token pair for each digital media asset of the digital media assets, wherein the token pair includes a first set of identifier tokens and a set of visual tokens representing features of a corresponding digital media asset, wherein the second set of tokens for the input visual timeline includes a second set of identifier tokens, and wherein the third set of tokens for the text input includes text tokens.

19. The system of claim 18, wherein the second set of tokens indicates an order of a subset of the digital media assets in the input visual timeline, and wherein each identifier token of the second set of identifier tokens includes a pointer to a token from the first set of tokens indicating a corresponding digital media asset.

20. The system of claim 18, wherein the operations further comprise:
generating each visual token of the set of visual tokens representing the features of the corresponding digital media asset by:
passing a digital media asset through a visual encoder to generate visual features of the digital media asset; and
mapping, by a projection layer, the visual features of the digital media asset into a visual token matching a dimensionality of the large language model.
